(19) United States
(12) Patent Application Publication
(10) Pub. No.: US 2015/0189355 A1
(43) Pub. Date: Jul. 2, 2015

(54) SYSTEMS AND METHODS FOR PRINTING THREE-DIMENSIONAL OBJECTS AS A REWARD

(71) Applicant: United Video Properties, Inc., Santa Clara, CA (US)

(72) Inventor: William J. Korbecki, Crystal Lake, IL (US)

(73) Assignee: UNITED VIDEO PROPERTIES, INC., Santa Clara, CA (US)

(21) Appl. No.: 14/141,189

(22) Filed: Dec. 26, 2013

(51) Int. Cl. H04N 21/41; H04N 21/4223; G06F 3/12; H04N 21/44; H04N 21/442

(52) U.S. Cl. CPC H04N 21/4117; H04N 21/44008; H04N 21/44218; G06F 3/1268; H04N 21/4223; B33Y 50/02

(57) ABSTRACT

Methods and systems are provided for providing as a reward an object for 3D printing. These methods and systems are provided by way of measuring an engagement level of a user with a user equipment device during a portion of a video presented to the user and identifying an object presented within the video being viewed by the user. The object associated with the media asset may be selected based on the user's viewing history. For example, in a scene where a coffee mug and a toy figurine are presented, and the user watching the video including the scene has previously viewed cartoons related to the toy figurine, the toy figurine may be selected based on the user's viewing history. A design file describing a three-dimensional representation of the object might be retrieved, and a request may be transmitted to a printer to print the three-dimensional representation of the object.

### BACKGROUND

Three-dimensional (3D) printing is an emerging technology that enables a user to “print” a 3D object based on an associated design file. For example, rather than purchase a mug from a store, a user may use a 3D printer to print a desired mug design. Today's 3D printers are cumbersome to use because a user must take the time and effort involved in not only choosing a design of a desired object, but also ensuring that design is viable given a user's cost constraints and compatible with the user's 3D printer and its capabilities.

### SUMMARY

Methods and systems are provided herein for providing as a reward an object for three-dimensional printing. These methods and systems are provided by way of measuring an engagement level of a user with a user equipment device during a portion of a video and identifying an object presented within the video being viewed by the user (e.g., a coffee mug or toy figurine). The object may be determined based on the user's viewing history. For example, in a scene where a coffee mug and a toy figurine are presented, and the user watching the video including the scene has previously viewed cartoons related to the toy figurine, the toy figurine may be selected based on the user's viewing history. A design file describing a three-dimensional representation of the object is then retrieved, and a request may be transmitted to a 3D printer to print the three-dimensional representation of the object. For example, if the toy figurine is selected, a design file reflecting 3D print specifications of the toy figurine is retrieved and utilized by the 3D printer to print a three-dimensional representation of the toy figurine.

In some aspects, a three-dimensional representation of an object may be printed as a reward for a user viewing a media asset on a user equipment device. It may be determined whether the user is engaged with the user equipment device during presentation of a portion of the media asset. Though the entire media asset may be presented to the user, the user's engagement with the user equipment device may be determined during only the portion of the media asset. Alternatively, the user's engagement with the user equipment device may be determined during the entire media asset. In response to determining that the user is engaged during the portion of the media asset presented to the user, an object associated with the media asset being viewed by the user may be retrieved. A design file may be retrieved describing a three-dimensional representation of the object. A request may be transmitted to a printer to print the three-dimensional representation of the object.

In some embodiments, in response to determining that the user is not engaged during the portion of the media asset presented to the user, a request may be transmitted to the printer to pause printing of the three-dimensional representation of the object. In some embodiments, the printing may be resumed in response to determining that the user is again engaged during the portion of the media asset presented to the user. In some embodiments, the portion of the media asset presented to the user may be a quarter, a half, or a three-quarter of the media asset. In some embodiments, determining whether the user is engaged with the user equipment device may include measuring an engagement level of the user with the user equipment device, retrieving a threshold value stored in a memory of the user equipment device, and determining whether the measured engagement level of the user with the user equipment device is above the threshold value.

In some embodiments, a quality of the printing of the three-dimensional representation of the object may be dependent on the measured engagement level. In some embodiments, tracking the facial position of the user with respect to the user equipment device may be used to measure the engagement level of the user with the user equipment device. In some embodiments, measuring the engagement level of the user with the user equipment device may include tracking a gaze point of the user with respect to the user equipment device, and setting a value to the engagement level of the user with the user equipment device based on the gaze-tracking.

In some embodiments, the object associated with the media asset may be determined based on a user profile. In some embodiments, the object associated with the media asset may be determined based on a viewing history for the user.

In some aspects, the systems and methods described herein include a method, a system or an apparatus for providing as a reward an object for three-dimensional printing accordingly to the functionality described above.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative embodiment of a display screen that may be used to provide media guidance application listings and other media guidance information, in accordance with some embodiments of the disclosure;

FIG. 2 shows another illustrative embodiment of a display screen that may be used to provide media guidance application listings, in accordance with some embodiments of the disclosure;

FIG. 3A is a block diagram of an illustrative user equipment device in accordance with some embodiments of the disclosure;

FIG. 3B is a block diagram of an eye tracker for identifying the gaze point of a user of a user equipment device in accordance with some embodiments of the disclosure;

FIG. 3C is another block diagram of a face tracker for identifying the gaze point of a user of a user equipment device in accordance with some embodiments of the disclosure;

FIG. 4 is a block diagram of an illustrative media system in accordance with some embodiments of the disclosure;

FIG. 5A shows an illustrative embodiment of a user equipment device that displays a video frame including selectable objects available for 3D printing, in accordance with some embodiments of the disclosure;

FIG. 5B shows an illustrative embodiment of a user equipment device that displays a video frame including selectable objects available for 3D printing, and reflects a user selection of objects, in accordance with some embodiments of the disclosure;

FIG. 6 shows an illustrative embodiment of user characteristics of a user profile, as well as objects in a video frame, in accordance with some embodiments of the disclosure;

FIG. 7 shows an illustrative embodiment of capabilities of a printer, in accordance with some embodiments of the disclosure;

FIG. 8 shows an illustrative embodiment of a first user equipment and a second user equipment device, where the second user equipment device displays selectable objects of a video frame presented at the first user equipment device, in accordance with some embodiments of the disclosure;

FIG. 9 is a flowchart of illustrative steps taken to print a three-dimensional object as a reward for a user viewing a media asset on a user equipment device, in accordance with some embodiments of the disclosure;

FIG. 10 is a flow diagram that describes the process in which a user's engagement level with a user equipment during presentation of a media asset is determined in step 902 of FIG. 9, in accordance with some embodiments of the disclosure; and

FIG. 11 is a flow diagram that describes the process in which a user's engagement level with a user equipment device is used to determine quality of a three-dimensional representation of an object, in accordance with some embodiments of the disclosure.

### DETAILED DESCRIPTION

Methods and systems are provided herein for providing as a reward an object for three-dimensional printing. These methods and systems are provided by way of measuring an engagement level of a user with a user equipment device during a portion of a video presented to a user and identifying an object presented within the video being viewed by the user (e.g., a coffee mug or toy figurine). An object may be selected based on the user's viewing history. For example, in a scene where a coffee mug and a toy figurine are presented, and the user watching the video including the scene has previously viewed cartoons related to the toy figurine, the toy figurine may be selected based on the user's viewing history. A design file describing a three-dimensional representation of the object may then be retrieved, and a request may be transmitted to a printer to print the three-dimensional representation of the object. For example, if the toy figurine is selected, a design file reflecting 3D print specifications of the toy figurine may be retrieved and utilized by the printer to print a three-dimensional representation of the toy figurine.

In some aspects, a three-dimensional object may be provided as a reward for a user viewing a media asset on a user equipment device. Control circuitry may determine whether the user is engaged with the user equipment device during presentation of a portion of a media asset, e.g., a video. Though the entire media asset may be presented to the user, the user's engagement with the user equipment device may be determined during only the portion of the media asset. In some embodiments, the portion of the media asset may include a quarter, a half, or a three-quarter of the duration of the media asset. Alternatively, the user's engagement with the user equipment device may be determined during the entire media asset. If the user is determined to be engaged with the user equipment device, the control circuitry may identify an object presented within the video being viewed by the user. The object may be identified automatically or may be identified via user input. The control circuitry may determine the object based on, e.g., a user profile or a user viewing history. For example, a frying pan may be selected by the control circuitry because of the user's viewing history that includes cooking television shows.

The control circuitry may retrieve a design file describing a three-dimensional representation of the object. For example, the design file may specify any object characteristic associated with a three-dimensional representation of the object for printing, such as (but not limited to) height, width, length, materials (e.g., plastic, metal, etc.), cost, color, and the like. The control circuitry may transmit a request to a printer to print the three-dimensional representation of the object in accordance with the specifications of the design file. For example, if the design file specifies a 3D representation of the frying pan is to be cast iron, ten inches in diameter, and to have a steel handle that is five inches long that is to be printed as a separate component, the control circuitry may send consistent instructions to the 3D printer to print a 3D representation of the frying pan that satisfies those specifications.

If the user is determined to not be engaged with the user equipment device, the control circuitry may transmit a request to pause printing of the three-dimensional representation of the object. The control circuitry may check if the user is again engaged with the user equipment device. If so, the control circuitry may transmit a request to resume printing of the three-dimensional representation of the object. If the user is still not engaged, the control circuitry may continue to monitor the user to determine whether to pause or resume printing of the three-dimensional representation of the object.

In some embodiments, the control circuitry may make a determination of which object in a video being viewed by a user is most relevant to the user. The control circuitry may identify user characteristics associated with a user profile or viewing history (e.g., printer capabilities or previously viewed media asset), and determine which object has a greatest number of object characteristics that match the user characteristics associated with the user profile or viewing history. For example, the control circuitry may determine that a beer mug is associated with characteristics such as football, and may determine that a user has a viewing history of watching football, and may therefore determine the beer mug shares more characteristics with the viewing history than other objects in a video.

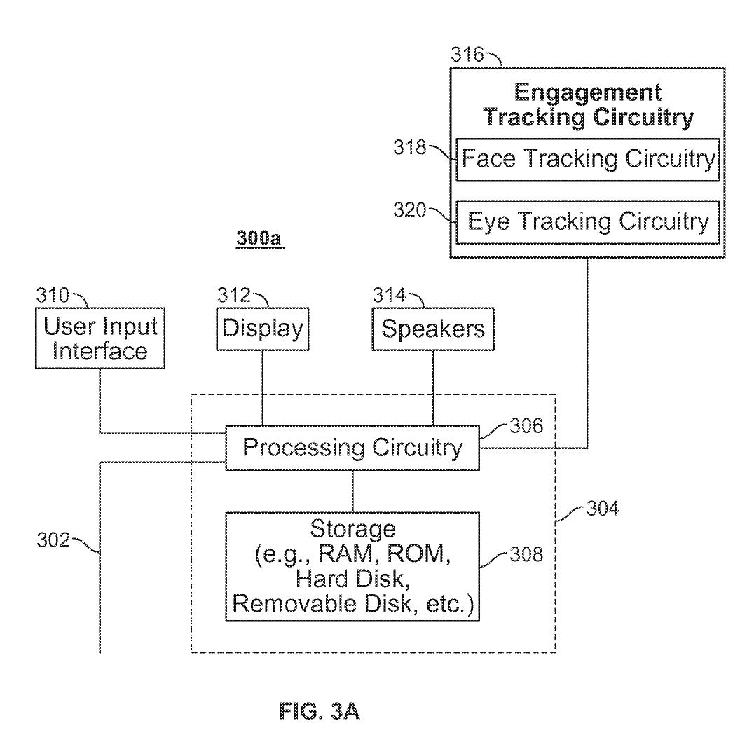

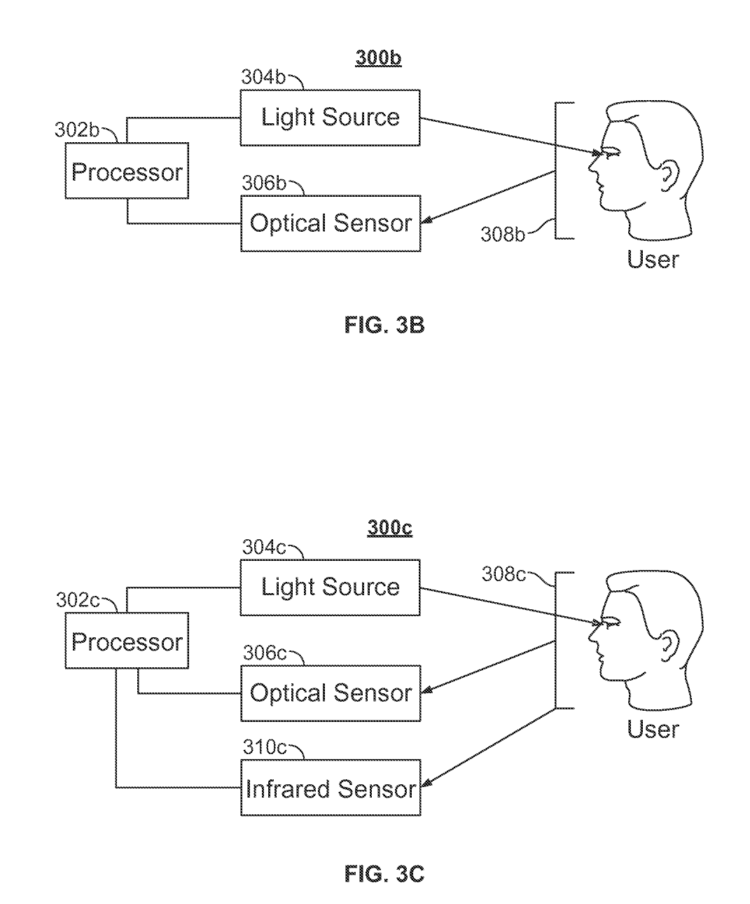

In some embodiments, control circuitry is configured to execute processes in which a user's engagement level with a user equipment device during presentation of a media asset is determined. In some embodiments, the portion of the media asset presented to the user may include a quarter, a half, or a three-quarter of the duration of the media asset. The control circuitry may calculate the user engagement level with the user equipment device using an eye contact score and a face tracking score. The control circuitry may perform a weighted average of the face tracking score and eye tracking to calculate the user engagement level with user equipment device. Further details regarding the scores are provided in relation to FIGS. 3B-3C.

In some embodiments, the control circuitry may retrieve a threshold value for the user engagement level from storage of the user equipment device. If the calculated user engagement value is above the retrieved threshold value, the control circuitry may return an indication that the user is engaged with the user equipment device. If the calculated user engagement value is not above the retrieved threshold value, the control circuitry may return an indication that the user is not engaged with the user equipment device.

In some embodiments, control circuitry is configured to execute processes in which a user's engagement level with a user equipment device during a portion of a media asset presented to the user is used to determine quality of a three-dimensional representation of an object. The control circuitry may measure an engagement level of the user with the user equipment device during a portion of a media asset presented to the user, e.g., a video. In some embodiments, the portion of the media asset presented to the user may include a quarter, a half, or a three-quarter of the duration of the media asset. The control circuitry may calculate the user engagement level with the user equipment device using an eye contact score and a face tracking score. The control circuitry may perform a weighted average of the face tracking score and eye tracking to calculate the user engagement level with user equipment device. Further details regarding the scores are provided in relation to FIGS. 3B-3C.

The control circuitry may retrieve a threshold value for the user engagement level from storage of the user equipment device. The control circuitry may determine the difference between the calculated user engagement level and the retrieved threshold value. If the difference is below or equal to zero, the control circuitry may return an indication that the user is not engaged with the user equipment device and transmit a request to pause printing of the three-dimensional representation of the object. If the determined difference is above zero, the control circuitry may determine the quality of the three-dimensional representation of the object to be printed based on the difference. For example, if the user is marginally engaged above the threshold value (e.g., the difference is less than 10% of the threshold value), the quality may be set to “low.” In another example, if the user is extensively engaged above the threshold value (e.g., the difference is more than 50% of the threshold value), the quality may be set to “high.” In some embodiments, a “high” quality three-dimensional representation of the object may have more details than the “low” quality representation. In some embodiments, a “high” quality three-dimensional representation of the object may include multiple colors while the “low” quality representation may be monochromatic. In some embodiments, a “high” quality three-dimensional representation of the object may be printed using materials different from those used for printing the “low” quality representation. The control circuitry may transmit a request to start or resume printing of the three-dimensional representation of the object according to the determined quality.

In some embodiments, the quality of the printed three-dimensional representation of the object may vary in quality as the measured engagement level of the user varies. In some embodiments, the quality may be locked in after a certain event, e.g., after the user has viewed more than half of the media asset, and subsequent user engagement level may not further affect the quality of the printed three-dimensional representation of the object.

The term “object” wherever used in this disclosure refers to any depiction within a media asset of a discrete item. Any individually recognizable item or component is within the scope of the definition of “object.” For example, if a frying pan is depicted, the frying pan as a whole may be the object, and components of the frying pan such as a handle or grip of the frying pan may also be an object.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

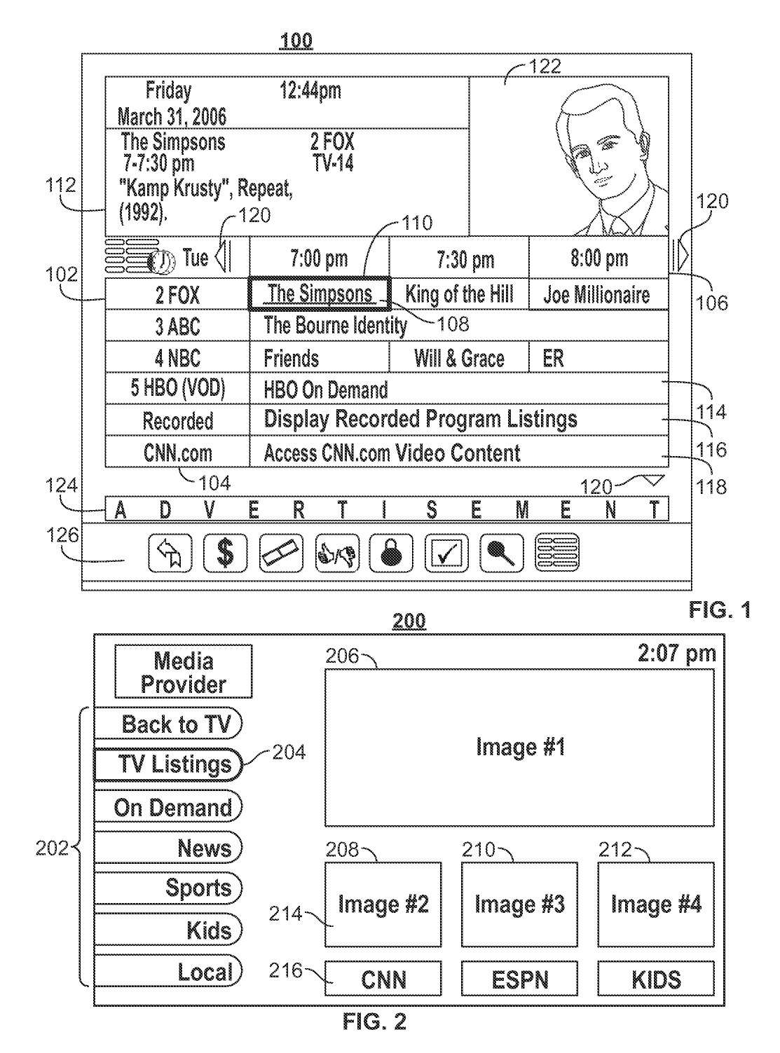

FIGS. 1-2 show illustrative display screens that may be used to provide media guidance data. The display screens shown in FIGS. 1-2 and 5-15 may be implemented on any suitable user equipment device or platform. While the displays of FIGS. 1-2 and 5-15 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

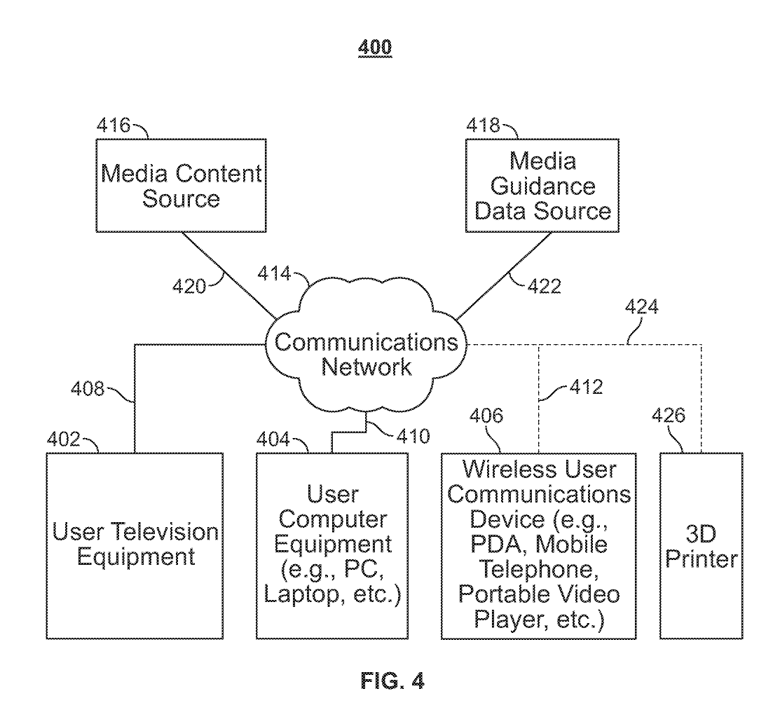

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

Users may access content and the media guidance application (and its display screens described above and below) from one or more of their user equipment devices. FIG. 3A shows a generalized embodiment of illustrative user equipment device 300a. More specific implementations of user equipment devices are discussed below in connection with FIG. 4. User equipment device 300a may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3A to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment device 300a. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment device 300a, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300a. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300a or may be stand-alone units. The audio component of videos and other content displayed on display 312 may be played through speakers 314. In some embodiments, the audio may be distributed to a receiver (not shown), which processes and outputs the audio via speakers 314.

User equipment device 300a may determine a user's level of engagement with display 312 using engagement tracking circuitry 316. In several embodiments, engagement tracking circuitry 316 may contain an eye tracker 320. Eye tracker 320 may receive a location upon which one or both of a user's eyes are focused. The location upon which a user's eyes are focused is referred to herein as the user's “gaze point.” In some embodiments, eye tracker 320 may monitor one of both eyes of a user of user equipment device 300a to identify a gaze point on display 312 for the user. Eye tracker 320 may additionally or alternatively determine whether one or both eyes of the user are focused on display 312 or focused on a location that is not on display 312. In some embodiments, eye tracker 320 includes one or more sensors that transmit data to processing circuitry 306, which determines a user's gaze point. Eye tracker 320 may be integrated with other elements of user equipment device 300a, or eye tracker 320 may be a separate device or system in communication with user equipment device 300a. Eye tracker 320 is described in further detail in relation to FIGS. 3B-3C.

In some embodiments, control circuitry 304 may be configured to assign an engagement level value based on the monitored eye tracking data. For example, control circuitry 304 may receive the gaze tracking data collected by eye tracker 320 and store that data in a memory unit such as storage 308. Control circuitry 304 may analyze the location of the gaze point with respect to display 312 to determine the engagement level of the user with respect to display 312. Control circuitry 304 may calculate an eye tracking score on the location of the user's gaze point at a given time with respect to display 312. Control circuitry 304 may store the calculated eye tracking score in a database in storage 308. Control circuitry 304 may factor in the eye tracking score along with several other parameters used to measure a user's engagement level to calculate a user engagement level value with user equipment device 300a.

In several other embodiments, engagement tracking circuitry 316 may include face tracker 318. Face tracker 318 may determine the position and orientation of the user's face with respect to display 312 in order to measure the level of user engagement with the displayed media asset. Face tracker 318 may use an optical device and facial recognition software in order to detect a user's face. Once a user's face has been detected, face tracker 318 may compare the detected face against a database of known user faces stored in a database in storage 308 using facial recognition software. For example, face tracker 318 may use an optical device to capture an image of a detected face within proximity of user equipment device 300a. Face tracker 318 may then use facial recognition software to process the captured image and compare the processed image against a database of registered users' faces stored in a database on storage 308. Once a matching face in the database of users' faces is found, processing circuitry 306 may identify the user profile associated with the detected face.

Face tracker 318 may monitor the position and orientation of the detected user's face once a matching user profile has been identified with the detected user's face. In particular, face tracker 318 may monitor the tilt of the face with relation to display 312. For instance, face tracker 318 may monitor whether the user is facing display 312 or whether the user's face has turned sideways and is not looking directly at display 312. The degree of the tilt between the user's face and display 312 is used to measure the engagement level of the user. Face tracker 318 may also monitor the position of the user's face with relation to display 312 to determine the distance between the user's face and display 312 and to determine the angle of the user's face from the center of display 312. Such data collected by face tracker 318 determines how likely the user is to be engaged with the media asset displayed on display 312.

In some embodiments, control circuitry 304 may be configured to assign an engagement level value based on the monitored face tracking data. For example, control circuitry 304 may receive the face tracking data collected by face tracker 318 and store that data in a memory unit such as storage 308. Control circuitry 304 may analyze data describing the user's facial orientation with respect to display 312 to determine the level of engagement of the user with the user equipment device 300a. For instance, control circuitry 304 may calculate a face tracking score based on the angle of the user's face with respect to display 312 measured by face tracker 318. Control circuitry 304 may additionally factor in the user's facial position with respect to display 312 to calculate the face tracking score. Once control circuitry 304 calculates such a face tracking score, control circuitry 304 may calculate an engagement level value using the face tracking score. For instance, control circuitry 304 may perform a weighted average of the face tracking score and the eye tracking score to calculate a total user engagement level value with user equipment device 300a.

Control circuitry 304 may store the calculated engagement level value in a database in storage 308. Control circuitry 304 may assign such an engagement level at periodic time intervals or continuously update a database of user engagement level with values of user engagement values based on the monitored eye tracking data received from eye tracker 320. In some embodiments, control circuitry 304 may also transmit the user's calculated engagement level value to other user equipment devices over a wireless network.

In some embodiments, face tracker 318 may capture a video of the user's face to measure the engagement level of the user. Alternatively, face tracker 318 may capture a set of image frames of a user's face. Control circuitry 304 may check for differences in facial features between different video frames or captured images. Control circuitry 304 may compare the differences in facial features, position, and orientation with respect to display 312 to update the user engagement level. For instance, control circuitry 304 may measure the change in facial features, position, and orientation with respect to display 312 for an image frame with respect to such data from an initial image frame. Control circuitry 304 may then accordingly adjust the face tracking score proportionately with respect to the offsets in these measured facial values for an image captured after an initially captured image of the user's face.

Face tracker 318 and eye tracker 320 may be used in combination to determine the engagement level of a user associated with a user profile with display 312. Processing circuitry 306 may use gaze tracking data and facial position and orientation data in combination to determine a composite score of the user's level of engagement with display 312. For example, processing circuitry 306 analyzes the face tracking and eye tracking data for each user and calculates a composite user engagement level score based on the analyzed data.

Engagement tracking circuitry 316 may also monitor whether a user is interacting with a secondary device in addition to user equipment device 300a to further refine the calculated value for a user's level of engagement with display 312. For instance, engagement tracking circuitry 316 may detect other electronic devices that the user is paying attention to.

In several embodiments, engagement tracking circuitry 316 detects whether a user is engaged with another user equipment device. Engagement tracking circuitry 316 may include a wireless transmitter and receiver for communicating with other user equipment devices over a wireless local area network connection. Engagement tracking circuitry 316 may transmit the user's level of engagement value with display 312 of that user equipment device to another user equipment device's engagement tracking circuitry. Once engagement tracking circuitry 316 receives the level of engagement value from another user equipment device, engagement tracking circuitry 316 adjusts the engagement level value of the user associated with a specific user profile with relation to its own display. Engagement tracking circuitry 316 may reduce the level of engagement of a user with a given device proportionately with respect to the user's level of engagement with another device. For instance, engagement tracking circuitry 316 may reduce the level of engagement value for a given device if it receives a high level of engagement value for the same user with another user equipment device. Engagement tracking circuitry 316 may decrease the engagement level value that may have been previously stored in storage 308 by an amount proportionate to the received user engagement level with another device. In another implementation engagement tracking circuitry 316 may reduce the engagement level value calculated by the face tracking and eye scores before storing the computed engagement level value into storage 308.

A local network of user equipment devices communicating user engagement level values calculated from facial tracking and eye tracking data for a given device with one another further refines the computed user engagement value for each given user equipment device in the network.

In some embodiments, control circuitry 304 may aggregate engagement level data received from multiple networked devices for a particular user with respect to each of the networked devices. For example, control circuitry 304 may receive user engagement level data for the user from several devices that the user is currently engaged with. If the user is using a smartphone, the smartphone may calculate an engagement level of the user with the smartphone and transmit that engagement level information to user equipment device 300a over the wireless network. If the user is using a tablet computer, the tablet computer may compute the user's engagement level with the tablet computer and transmit that information to user equipment device 300a. Control circuitry 304 may aggregate the user's engagement level with respect to the various networked devices such as the smartphone and the tablet computer. Control circuitry 304 may factor these engagement vales with the engagement value calculated at the user equipment device 300a for the user with respect to display 312. In this manner, engagement tracking may be distributed across several networked devices and aggregated by control circuitry 304.

In another embodiment, engagement tracking circuitry 316 may detect that the user is engaged with another device using an optical device. For instance, engagement circuitry may detect that a user is talking on a telephone by processing a captured image of the user talking on the phone. Accordingly, control circuitry 304 adjusts the user's engagement level when it determines that user is engaged with another device from an image or a video capture. For example, control circuitry 304 may scan a captured image to detect a cellphone or another electronic device in the hands of a user. Control circuitry 304 may decrease the user's previously calculated engagement level proportionately based on the user's activity with the cellphone or any other secondary electronic device.

In some embodiments, engagement tracking circuitry 316 may monitor the applications and content running on user equipment device 300a. For instance, if a user is using a social media application on his smartphone, the smartphone's engagement tracking circuitry 316 is able to monitor that the user is currently using a social media application and use that information to calculate a user engagement value for the user with respect to the smartphone. The calculated user engagement value on the networked smartphone may be transmitted to other user equipment devices to adjust the user's engagement value with those devices in light of his engagement with the social media application use on the smartphone. Control circuitry 304 may be configured to receive the engagement value of the user with respect to the smartphone and decrease the user engagement level with respect to user equipment device 300a. Control circuitry 304 may decrease the engagement level value that may have been previously stored in storage 308 by an amount proportionate to the received user engagement level from the smartphone. In another implementation engagement tracking circuitry 316 may reduce the engagement level value calculated by the face tracking and eye scores before storing the computed engagement level value into storage 308. Although a smartphone has been used an example in this discussion, the method described may be used with any electronic device capable of transmitting data over a wireless network.

In yet another embodiment, engagement tracking circuitry 316 may determine a user's level of engagement by determining if the user is engaged in a conversation. Engagement tracking circuitry 316 may include audio detection circuitry such as a microphone and audio recognition software that is able to identify that the user associated with a user profile is engaged in a conversation. Accordingly, control circuitry 304 adjusts the user's engagement level when it determines that user is engaged in a conversation. For example, control circuitry 304 may receive audio data from a microphone and process a received sound file to detect whether a user is engaged in a conversation. Control circuitry 304 may detect the user's voice by comparing the audio profile from the sound file a database of user audio profiles. Control circuitry 304 may retrieve such a database of audio profiles from storage 308. Once control circuitry 304 determines that it is indeed the user who is engaged in a conversation, control circuitry 304 may decrease the engagement level of the user with respect to user equipment device 300a.

In another embodiment, control circuitry 304 may determine whether a user is engaged in a conversation with other users about the media asset being displayed on user equipment device 300a. Control circuitry 304 may be configured to identify certain keywords associated with the media asset being displayed. For instance, control circuitry 304 may receive keywords associated with a media asset from a media content source. Control circuitry 304 may store the received keywords in storage 308. Control circuitry 304 may also receive audio data from one or more microphones located in the viewing region of user equipment device 300a. Control circuitry 304 may process the received audio data to detect whether a user is talking about the program. Control circuitry 304 may process the received audio using audio detection or speech recognition algorithms. Control circuitry 304 may further compare the processed audio against the keywords stored in storage 308 that are related to the currently displayed media asset.

Once control circuitry 304 detects that the user is talking about the media asset currently displayed on user equipment device 300a, control circuitry 304 may modify the user's engagement level. For example, control circuitry 304 may detect which user is talking about the currently displayed media asset by comparing the detected voice from the received audio against the database of user profiles stored in storage 308. Once control circuitry 304 identifies which user is speaking about the currently displayed media asset, control circuitry 304 may increase the detected user's engagement level with respect to user equipment device 300a. As an example, if control circuitry 304 detects that the user spoke out loud the title of the media asset being currently displayed on user equipment device 300a, control circuitry 304 may increase the user's engagement level with user equipment device 300a. In another embodiment, control circuitry 304 may increase the user engagement level by an amount proportionate to the frequency in which the user mentions keywords related to the currently displayed media asset on user equipment device 300a.

In another embodiment, control circuitry 304 may detect whether a user is engaged in conversation with another user present in the viewing region of the user equipment device 300a. For example, control circuitry 300 may detect whether multiple users present in the viewing region of user equipment device 300a are conversing. Control circuitry 304 may be configured to detect that multiple users are speaking with one another using information acquired from engagement tracking circuitry 316. For example, control circuitry 304 may analyze audio and image data received from engagement tracking circuitry 316 to determine that multiple users are speaking with one another. If control circuitry 304 determines that the users are talking about the media asset currently displayed, control circuitry 304 may increase the users' engagement level with user equipment device 300a. Alternatively, if control circuitry 304 determines that the users are not talking about the media asset currently displayed on user equipment device 300a, control circuitry 304 may decrease the user engagement levels of the users that it detects are engaged in a topic not related to the currently displayed media asset.

In another embodiment, control circuitry 304 may determine a user's engagement level with user equipment device 300a by monitoring the user's interactions with the device from the amount of communications received from the user through user input interface 310. Such user interaction data is processed by control circuitry 304 and is passed to engagement tracking circuitry 316 to factor into a total calculation of the user's engagement level.

Storage 308 may include a stored database of user profiles associated with user equipment device 300a. Each user profile may include at least one or more images of a user's face, parental control settings associated with the user, age, media viewing preferences of the user, and a threshold value for the user's engagement level. A user profile may include data describing the user's content authorization level. The content authorization level comprises a set of rules that governs what types of content the user associated with the user profile is permitted to access. For example, a user may be permitted to access media content associated with specific parental control ratings, genres, subjects, and broadcast times. A user profile may also include a default user engagement level threshold. An engagement level threshold is a numerical measure of a user's level of activity with user equipment device 300a. Such a value may be calibrated in accordance with the techniques in which control circuitry 304 calculates a user engagement level using data from eye tracker 320, face tracker 318, and any other components of engagement tracking circuitry 316.

After control circuitry 304 calculates the engagement level for a user, control circuitry 304 may compare the calculated engagement level value against the user's threshold engagement value to determine if the user is adequately engaged with user equipment device 300a. For example, control circuitry 304 may retrieve the threshold user engagement value from the user's profile stored in a memory of the first user equipment device, such as storage 308. Upon retrieving such a threshold value, control circuitry 304 may compare the previously calculated user engagement level, which may be stored in storage 308, against the threshold user engagement level threshold. Alternatively, control circuitry 304 may be configured to retrieve the user engagement level threshold from an alternative storage location. If control circuitry 304 determines that the calculated user engagement level value matches or exceeds the user engagement threshold, control circuitry 304 may store an indication that the user is sufficiently engaged with user equipment device 300a. On the other hand, if control circuitry 304 determines that the calculated user engagement level value is less than the stored user engagement threshold, control circuitry 304 may determine that the user is not sufficiently engaged with user equipment device 300a and may store this information.

A user may be allowed to modify the user engagement threshold value for one or more user profiles. For instance, a user can modify the engagement level threshold for one or more user profiles to a desired level through user input interface 310. Control circuitry 304 may receive the user's changes inputted using user input interface 310 and accordingly modify the threshold engagement level value for a user profile stored in storage 308 with an updated value to be used in the future.

In some embodiments, control circuitry 304 may monitor a user's engagement level once it determines that the user is not sufficiently engaged with user equipment device 300a. Control circuitry 304 may periodically check to determine whether a user is sufficiently engaged with user equipment device 300a before taking any action resulting from the user's level of engagement having changed to not sufficient engaged. For example, when control circuitry 304 first determines that a user's engagement level has fallen below the engagement level threshold, control circuitry 304 may begin running a countdown timer for a predetermined amount of elapsed time of acceptable minimal engagement. Control circuitry 304 may periodically measure the user's engagement level value and check against the threshold engagement value to determine if the user has increased his engagement level value to a value above the threshold during this predetermined period of time. Alternatively, control circuitry 304 may continuously measure the user's engagement level value and check against the threshold engagement value to determine if the user has increased his engagement level value to a value above the threshold during this predetermined period of time. If control circuitry 304 determines that the user has not raised his engagement level above the threshold value, control circuitry 304 may take certain actions as necessary and described below.

FIG. 3B shows an embodiment of eye tracker 300b for identifying the gaze point of a user 308b of user equipment device 300a. Eye tracker 300b includes processor 302b, light source 304b, and optical sensor 306b. Light source 304b transmits light that reaches at least one eye of a user, and optical sensor 306b is directed at the user to sense reflected light. Optical sensor 306b transmits collected data to processor 302b, and based on the data received from optical sensor 306b, processor 302b determines a user's gaze point.

In some embodiments, eye tracker 300b is configured for determining a gaze point of a single user. In other embodiments, eye tracker 300b may determine gaze points for a plurality of users. Eye tracker 300b may identify multiple users of user equipment device 300a, and a user of user equipment device 300a or eye tracker 300b may select one of the identified users whose eyes will be tracked.

Processor 302b may be integrated with one or more light source 304b and one or more optical sensor 306b in a single device. Alternatively, one or more light sources 304b and one or more optical sensors 306b may be housed separately from processor 302b and in wireless or wired communication with processor 302b. One or more of processor 302b, light source 304b, and optical sensor 306b may be integrated into user equipment device 300a.

Processor 302b may be similar to processing circuitry 306 described above. In some embodiments, processor 302b may be or integrated within processing circuitry 306, with processing circuitry 306 in communication with light source 304b and optical sensor 306. In other embodiments, processor 302b may be separate from but optionally in communication with processing circuitry 306.

Light source 304b transmits light to one or both eyes of one or more users. Light source 304b may emit, for example, infrared (IR) light, near infrared light, or visible light. The light emitted by light source 304b may be collimated or non-collimated. The light is reflected in a user's eye, forming, for example, the reflection from the outer surface of the cornea (i.e., the first Purkinje image), the reflection from the inner surface of the cornea (i.e., the second Purkinje image), the reflection from the outer (anterior) surface of the lens (i.e., the third Purkinje image), and/or the reflection from the inner (posterior) surface of the lens (i.e., the fourth Purkinje image).

Optical sensor 306b collects visual information, such as an image or series of images, of one or both of one or more users' eyes. Optical sensor 306b transmits the collected image(s) to processor 302b, which processes the received image(s) to identify a glint (i.e., corneal reflection) and/or other reflection in one or both eyes of one or more users. Processor 302b may also determine the location of the center of the pupil of one or both eyes of one or more users. For each eye, processor 302b may compare the location of the pupil to the location of the glint and/or other reflection to estimate the gaze point. Processor 302b may also store or obtain information describing the location of one or more light sources 304b and/or the location of one or more optical sensors 306b relative to display 312. Using this information, processor 302b may determine a user's gaze point on display 312, or processor 302b may determine whether or not a user's gaze point is on display 312.

In particular, processor 302b may identify locations on display 312 using a coordinate system, and processor 302b may identify an (x, y) coordinate representing the user's gaze point on display 312. For example, for a rectangular display, the lower left hand corner may be considered the origin and be assigned the coordinates (0,0). Moving up display 312, the y-coordinate increases, and moving towards the right on the display, the x-coordinate increases. Any scale for the x and y axes may be used. Alternative coordinate system may be used; for example, the center point of display 312 may be the origin, or any other corner of display 312 may be the origin. The locations of light sources 304b and/or sensors 306b may be identified using this coordinate system. The coordinate system may include a third dimension.

In some embodiments, eye tracker 300b performs best if the position of the user's head is fixed or relatively stable. In other embodiments, eye tracker 300b is configured to account for a user's head movement, which allows the user a more natural viewing experience than if the user's head were fixed in a particular position.

In some embodiments accounting for a user's head movement, eye tracker 300b includes two or more optical sensors 306b. For example, two cameras may be arranged to form a stereo vision system for obtaining a 3D position of the user's eye or eyes; this allows processor 302b to compensate for head movement when determining the user's gaze point. The two or more optical sensors 306b may be part of a single unit or may be separate units. For example, user equipment device 300a may include two cameras used as optical sensors 306b, or eye tracker 300b in communication with user equipment device 300a may include two optical sensors 306b. In other embodiments, each of user equipment device 300a and eye tracker 300b may include an optical sensor, and processor 302b receives image data from the optical sensor of user equipment device 300a and the optical sensor of eye tracker 300b. Processor 302b may receive data identifying the location of optical sensors 306b relative to display 312 and/or relative to each other and use this information when determining the gaze point.

In other embodiments accounting for a user's head movement, eye tracker 300b includes two or more light sources for generating multiple glints. For example, two light sources 304b may create glints at different locations of an eye; having information on the two glints allows the processor to determine a 3D position of the user's eye or eyes, allowing processor 302b to compensate for head movement. Processor 302b may also receive data identifying the location of light sources 304b relative to display 312 and/or relative to each other and use this information when determining the gaze point.

In some embodiments, other types of eye trackers that do not utilize a light source may be used. For example, optical sensor 306b and processor 302b may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye tracker 300b.

FIG. 3C shows an embodiment of face tracker 300c for identifying the facial position and tilt of a user 308c of user equipment device 300a with respect to display 312. Face tracker 300c includes processor 302c, light source 304c, image sensor 306c. Light source 304c transmits light that reaches the face of a user, and image sensor 306c and infrared sensor 310c are directed at the user's face to sense reflected light. Image sensor 306c transmits collected data to processor 302c, and based on the data received from image sensor 306c, processor 302c determines a user's facial position and tilt.

In some embodiments, face tracker 300c is configured for determining facial position and tilt of a single user. In other embodiments, face tracker 300c may determine facial position and tilt for a plurality of users. Face tracker 300c may identify multiple users of user equipment device 300a, and a user of user equipment device 300a or face tracker 300c may select one of the identified users whose faces will be tracked.

Light source 304c transmits light to the face of one or more users. Light source 304c may emit, for example, infrared (IR) light, near infrared light, or visible light. The light emitted by light source 304c may be collimated or non-collimated. The light from light source 304c illuminates user's face 308c for image sensor 306c and infrared 306c to capture a clear image of the user's face.

Image sensor 306c and infrared sensor 310c collect visual information, such as an image or series of images, of one or more users' faces. Image sensor 306c and infrared sensor 310c transmit the collected image(s) to processor 302c, which processes the received image(s) and implements a facial detection algorithm on the collected image(s). The facial detection algorithm may process the captured image(s) and compare the processed images against a database of previously stored users' faces in storage 308. A database of user profiles associated with the user equipment device 300a may be stored in storage 308. Each user profile in such a database may contain one or more images of the user associated with the user profile. Processor 302c may compare the processed image(s) received from image sensor 306c and infrared sensor 310c against the stored image(s) in the user profile database to identify which user profile corresponds to the detected user. Once the user is identified, control circuitry 304 adds the detected user profile to a list of active user profiles near the user equipment device 300a.

Face tracker 300c may use image sensor 306c and infrared sensor 310c in tandem or may use only image sensor 306c or infrared sensor 310c.

Processor 302c may also determine the location of a user's face with relation to display 312. Processor 302c may measure the size of the face in the image(s) captured by optical sensor 306c to determine the distance of the user from display 312.

Processor 302c may also determine the tilt and orientation of a user's face with relation to display 312. Processor 302c may process the captured image(s) of a user's face and may execute a facial feature detection algorithm to determine the degree of tilt of a user's face with respect to the optical sensor. Since the optical sensor may be placed near or attached to display 312, the degree of tilt of a user's face from the optical sensor will be the same degree of tilt from display 312. Such an algorithm will detect whether the user is looking straight at display 312 or is looking away from display 312.

Image sensor 306c and infrared sensor 310c may collect a series of images or a video of the user's face. By analyzing the series of images or different video frames captured over a span of time, processor 302c may execute a facial tracking algorithm to determine changes in the position and orientation of face 308c with respect to a display device such as display 312.

In some embodiments accounting for a user's head movement, face tracker 318 includes two or more optical sensors 306c. For example, two cameras may be arranged to form a stereo vision system for obtaining a 3D position of the user's face; this allows processor 302c to compensate for head movement when determining the facial position. The two or more optical sensors 306c may be part of a single unit or may be separate units. For example, user equipment device 300a may include two cameras used as optical sensors 306c, or face tracker 318 in communication with user equipment device 300a may include two optical sensors 306c. In other embodiments, each of user equipment device 300a and face tracker 300c may include an optical sensor, and processor 302c receives image data from the optical sensor of user equipment device 300a and the optical sensor of face tracker 300c. Processor 302c may receive data identifying the location of optical sensors 306c relative to display 312 and/or relative to each other and use this information when determining the user's facial position and tilt.

In some embodiments, other types of face trackers that do not utilize a light source may be used. Any other equipment or method for determining one or more users' facial position and tilt not discussed above may be used in addition to or instead of the above-described embodiments of face tracker 300c.

The guidance application may be implemented using any suitable architecture. For example, it may be a stand-alone application wholly implemented on user equipment device 300a. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300a is retrieved on-demand by issuing requests to a server remote to the user equipment device 300a. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300a of FIG. 3A can be implemented in system 400 of FIG. 4 as user television equipment 402, user computer equipment 404, wireless user communications device 406, 3D printer 426, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below. Various methods and systems for utilizing 3D printers are discussed in, for example, Abeloe, U.S. Pat. No. 8,243,334, filed Jun. 5, 2009, Lai et al., U.S. Patent Publication No. 2008/0260918, filed Apr. 23, 2007, and Jandeska, Jr. et al. U.S. Pat. No. 7,141,207, filed Aug. 30, 2004, which are hereby incorporated by reference herein in their entireties.

A user equipment device utilizing at least some of the system features described above in connection with FIG. 3A may not be classified solely as user television equipment 402, user computer equipment 404, a wireless user communications device 406, or 3D printer 426. 3D printer 426 may be used to achieve the objects of the description above and below. User television equipment 402 may, like some user computer equipment 404 or 426, be Internet-enabled allowing for access to Internet content, while user computer equipment 404 or 426 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, wireless user communications device 406, and 3D printer 426 are coupled to communications network 414 via communications paths 408, 410, 412, and 424 respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, 412, and 424 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408, 410, and 424 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, 412, and 424 as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, 412, and 424. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, 406, and 426 are shown as through communications network 414, in some embodiments, sources 416 and 418 may communicate directly with user equipment devices 402, 404, 406, and 426 via communication paths (not shown) such as those described above in connection with paths 408, 410, 412, and 426.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300a. In some embodiments, media guidance applications may be client-server applications where only a client application resides on the user equipment device, and server application resides on a remote server. For example, media guidance applications may be implemented partially as a client application on control circuitry 304 of user equipment device 300a and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, wireless user communications device 406, and 3D printer 426. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3A.

In some embodiments, a request to print a 3D representation of an object appearing in a media asset may be transmitted to a 3D printer. Control circuitry (e.g., control circuitry 304) may identify an object presented within a video being viewed by a user. Control circuitry 304 may determine the object based on a user profile or a viewing history for the user. For example, if a child is watching a video that includes a toy among other adult objects, control circuitry 304 may select the object associated with the print request to be the toy. A design file may be retrieved that describes a three-dimensional representation of the object. The design file may be retrieved locally (e.g., from a DVD or BLU-RAY drive) or remotely (e.g., from a remote database). Upon retrieval, a request may be transmitted to a printer (e.g., 3D printer 426) to print the 3D representation of the object.

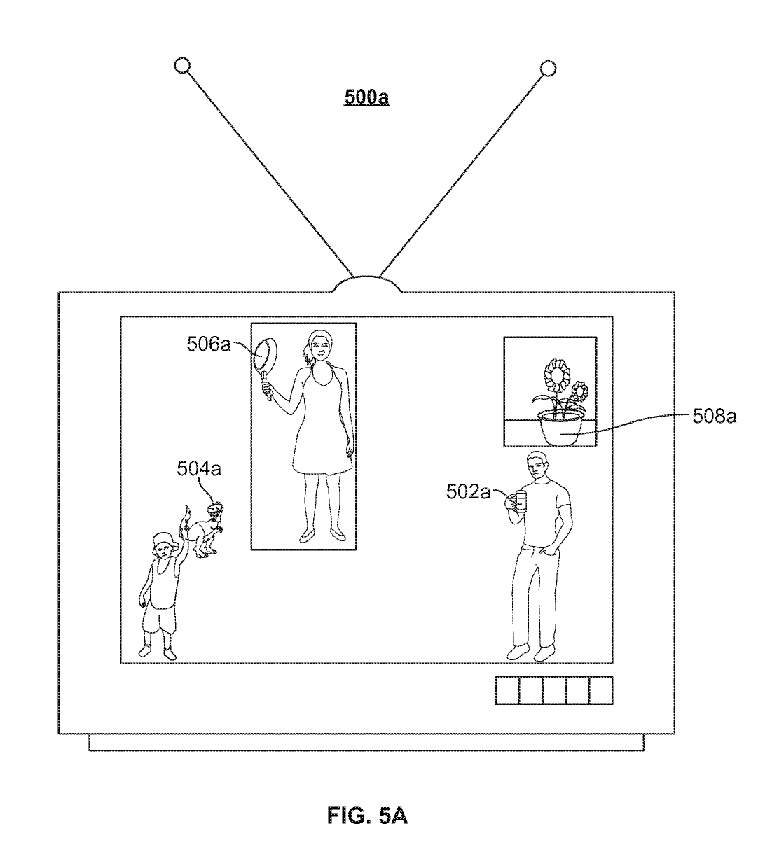

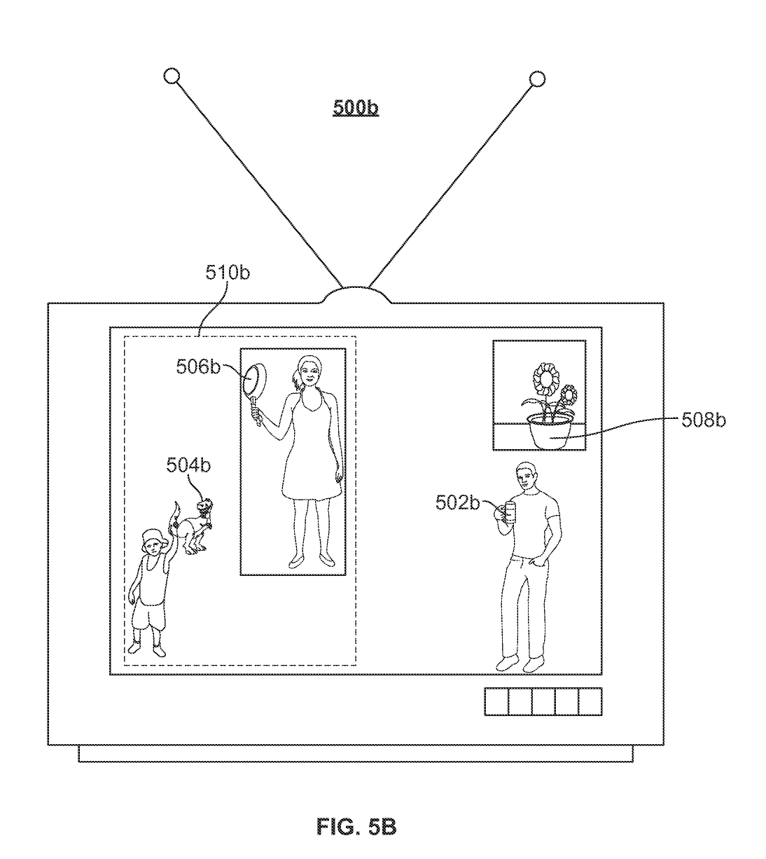

FIG. 5A shows an illustrative embodiment of a user equipment device that may display a video frame including selectable objects available for 3D printing, in accordance with some embodiments of the disclosure. User equipment 500a (e.g., a television) depicts a video that is being viewed by a user. The video may be, for example, broadcast television, Internet video, on-demand video, or video from any other source. Control circuitry 304 may identify an object presented within a video being viewed by a user. The object may be identified by accessing a database such as media guidance data source 418 or media content source 416 via communications network 414. The database may, for example, store data that indicates certain objects that appear in a video frame, a video scene, or a video in its entirety. For example, if an action movie like James Bond is playing, and there a scene with a poker game is playing, media guidance data source may store data indicating that a poker chip object is available in a presently displayed frame or at a present elapsed time. Alternatively, media guidance data source may store data indicating that a poker chip object is available in a presently displayed scene or in a specific window of elapsed time. Alternatively, media guidance data source may store data indicating that a poker chip is an object that appears during the duration of the movie as a whole.

In FIG. 5A, a scene is depicted where a man is holding beer mug 502a, a child is holding toy dinosaur 504a, a woman is holding frying pan 506a, and a flower pot 508a is resting on a window sill. Control circuitry 304a may access a database (e.g., media guidance data source 418) via communications network 414 to determine that each of beer mug 502a, toy dinosaur 504a, frying pan 506a, and flower pot 508a is an object in the presently displayed scene. Control circuitry 304 may select one object based on a user profile. The basis for this selection may be, for example, a determination by control circuitry 304 of which object is most relevant to a user based on a user profile or a viewing history for the user. The user profile may also include any or all of a 3D printing history, 3D printing preferences, demographic information, previously viewed media assets, and the like.

In order to make the selection, control circuitry 304 may identify user characteristics associated with a user profile or a viewing history. For example, if Patsy, a forty-year old woman who enjoys watching cooking shows, is watching the presently viewed scene, control circuitry 304 may determine that the user profile reflects user characteristics such as the gender, age, and interests of Patsy. Control circuitry 304 may then determine which object has the greatest number of object characteristics that match the user characteristics associated with the user profile. For example, control circuitry 304 may determine that Patsy is of legal drinking age, and that an object characteristic of the beer mug is that it should be marketed to consumers above the legal drinking age of twenty-one. Control circuitry 304 may determine that toy dinosaur 504a is designed for consumers under the age of 14, so it shares no characteristics with Patsy. Control circuitry 304 may determine that frying pan 506a is associated with people over the age of 16 who are safely capable of cooking, and may determine that Patsy enjoys cooking based on the fact that Patsy enjoys cooking shows. Control circuitry 304 may determine that flower pot 508a is enjoyed by people over the age of 30. Based on the above determinations, control circuitry 304 may designate frying pan 506a as the selected object because it shares two characteristics with Patsy's user profile, which is more than the number of characteristics of any other object in the video frame shared with Patsy's user profile.

In some embodiments, control circuitry 304 may select an object based on a user profile in a manner described in commonly-owned U.S. patent application Ser. No. 14/133,125, filed Dec. 18, 2013, and then retrieve a design file describing a 3D representation of the object. Control circuitry 304 may retrieve the design file from media guidance data source 418 via communications network 414. Alternatively, control circuitry 304 may retrieve the design file from a local storage 308 such as a hard disk or an optical drive (e.g., a BLU-RAY disc that the movie is being played from).

Control circuitry 304 may transmit a request to a printer (e.g., 3D printer 426) to print the 3D representation of the object. For example, as in the example above, a request may be transmitted to print a 3D representation of frying pan 506a. 3D printer 426 may have the capability to print using plastics, metals, or both, in addition to any other known printing material. 3D printer 426 may print frying pan 506a in one solid piece, or in discrete components that must be automatically or manually assembled. 3D printer 426 may be a printer that is local to user equipment 500, or may be remote from user equipment 500, where the request would travel via communications network 414. 3D printer may have the capability to print edible food. Methods and systems for utilizing 3D printers to print edible food are discussed in, for example, Lai et al., U.S. Patent Publication No. 2008/0260918, filed Apr. 23, 2007, which is hereby incorporated by reference herein in its entirety.

In some embodiments, control circuitry 304 may receive a user selection of an area of a video frame from which an object is to be selected. For example, a user may input a geometric shape around a portion of a video scene (e.g., via user input interface 310). Control circuitry 304 may limit the selection to those objects that are within the area of the input geometric shape.

FIG. 5B shows an illustrative embodiment of a user equipment device that may display a video frame including selectable objects available for 3D printing, and may reflect a user selection of objects, in accordance with some embodiments of the disclosure. Control circuitry 304 may receive a user input of geometric shape 510b intended to select an in a video frame via user input interface 310. Control circuitry 304 may detect input via any known peripheral device, such as a mouse cursor, remote control, or interactive touch screen device that may interact with a stylus or a finger.

A set of contact points of the input device (e.g., the points a stylus or cursor touches during input) may define a perimeter of geometric shape 510b. Control circuitry 304 may determine whether geometric shape 510b includes an object within its area by comparing the coordinates of the contact points against the coordinates of the objects, where when the coordinates of an object are within the area of the contact points, a positive determination may be made.

Control circuitry 304 may identify only objects that are within the area of geometric shape 510b as being part of identified objects presented within a video being viewed by the user, to the exclusion of other objects presented within the video. Control circuitry 304 may perform its selection of the object any manner described in the foregoing. Control circuitry 304 may then retrieve a design file describing a three-dimensional representation of the selected object, and may transmit a request to a printer to print the three-dimensional representation of the selected object.

In some embodiments, user characteristics of a user's profile or a viewing history may be associated with a user profile or a viewing history at a database (e.g., media guidance data source 418). The user characteristics may be updated by control circuitry 304 in response to certain actions, such as media being consumed or objects being printed. Media guidance data source 418 may also store objects in a scene of a video, such that control circuitry 304 may compare the object characteristics with those of the objects.

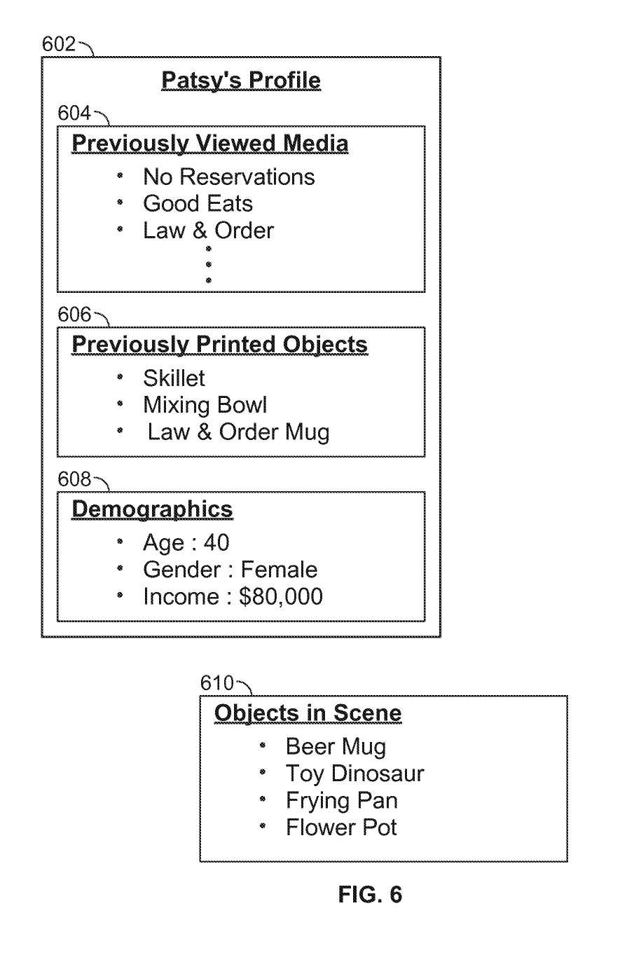

FIG. 6 shows an illustrative embodiment of user characteristics of a user profile, as well as object characteristics of objects in a video frame, in accordance with some embodiments of the disclosure. Database entry 602 may include data associated with Patsy's user profile. Database entry 602 may be stored as a data structure, or as a record in a database. While entry 602 includes previously viewed media 604, previously printed objects 606, and demographics 608, this is merely illustrative and a user profile may include any data associated with or relating to a user, such as credit card purchases, geographical information, user equipment capabilities, capabilities of 3D printer 426, etc. Data entry 602 may be utilized to identify user characteristics associated with the user profile, as discussed in the foregoing.

Previously viewed media 604 may comprise a viewing history and may include television shows, such as “No Reservations,” “Good Eats,” “Law and Order,” and any other media that Patsy has previously viewed. In some embodiments, the viewing history may be stored independently of the user profile. Previously printed objects 606 may include a skillet, a mixing bowl, and a “Law and Order” mug, as well as any other objects Patsy has printed. Demographics 608 may reflect any known or guessed demographics of a user, such as age, gender, income, or any other demographic. Control circuitry 304 may utilize user profile 602 to determine which object to select for printing at 3D printer 426.

Data entry 610 is illustrated to reflect objects in a scene, such as that displayed on user equipment 500a; however, as discussed in the foregoing, data entry 610 may reflect objects based on other factors, such as an elapsed time of a video. Data entry 610 may reflect that objects in a scene include a beer mug (e.g., beer mug 502a), a toy dinosaur (e.g., toy dinosaur 504a), a frying pan (e.g., frying pan 506a), and a flower pot (e.g., flower pot 508a). Though not illustrated, data entry 610 may include detailed object characteristics associated with each object. For example, data entry 610 may reflect that a beer mug object is associated with an age of twenty-one or higher. As another example, data entry 610 may reflect that a toy dinosaur object is associated with plastic, and that a frying pan is associated with a metal, such as iron. These detailed object characteristics may be used for selecting an object for printing (e.g., by determining which object shares the most characteristics with a user profile, as discussed in the foregoing).

In some embodiments, a data entry may be stored at a database (e.g., media guidance data source 418) that describes the capabilities of a 3D printer. Control circuitry 304 may access the database (e.g., via communications network 414) to retrieve the printer capabilities. As described in commonly-owned U.S. patent application Ser. No. 14/133,125, filed Dec. 18, 2013, printer capabilities may be a factor in determining which object to print.

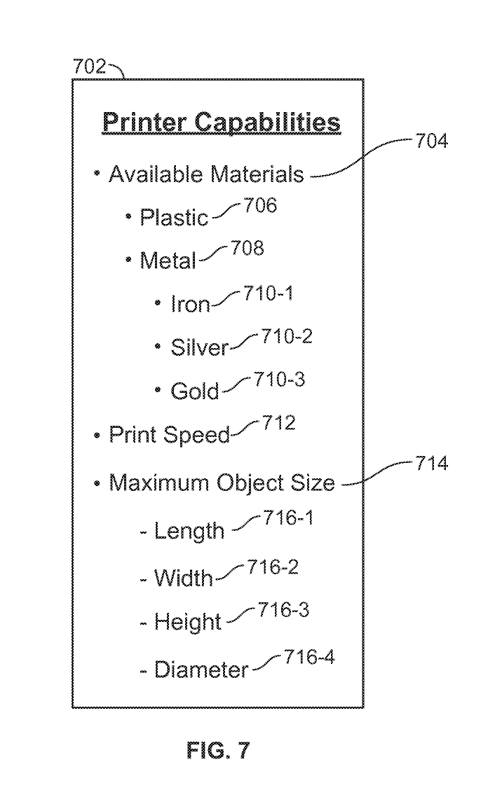

FIG. 7 shows an illustrative embodiment of capabilities of a printer, in accordance with some embodiments of the disclosure. As described in the foregoing, control circuitry 304 may determine which object to transmit a request for printing for based on printer capabilities, such as those described in database entry 702. Database entry 702 may be stored in a data structure, or as a record in a database. Control circuitry 304 may access database entry 702 by querying a database such as media guidance data source 418 via communications network 414. Alternatively, 3D printer 426 may store data entry 702 (e.g., at storage 308), and control circuitry 304 may query 3D printer 426 to learn of 3D printer 426's printing capabilities.

The printer capabilities of FIG. 7 that are depicted in data entry 702 are merely illustrative and are not intended to be comprehensive. Data entry 702 reflects the materials available to 3D printer 426 (e.g., plastic or metal) in item 704. Item 704 may indicate that only one type of plastic 706 is available. Item 704 may indicate that three types of metal 708 are available to 3D printer 426 (e.g., iron 710-1, silver 710-2, and gold 710-3). Item 712 may indicate one or more print speeds of 3D printer 426. Item 714 may indicate a maximum object size of that 3D printer 426 is capable of printing. Any of items 716-1, 716-2, 716-3 may be reflected in item 714 to indicate a maximum size in terms of length, width, height, or diameter of an object.

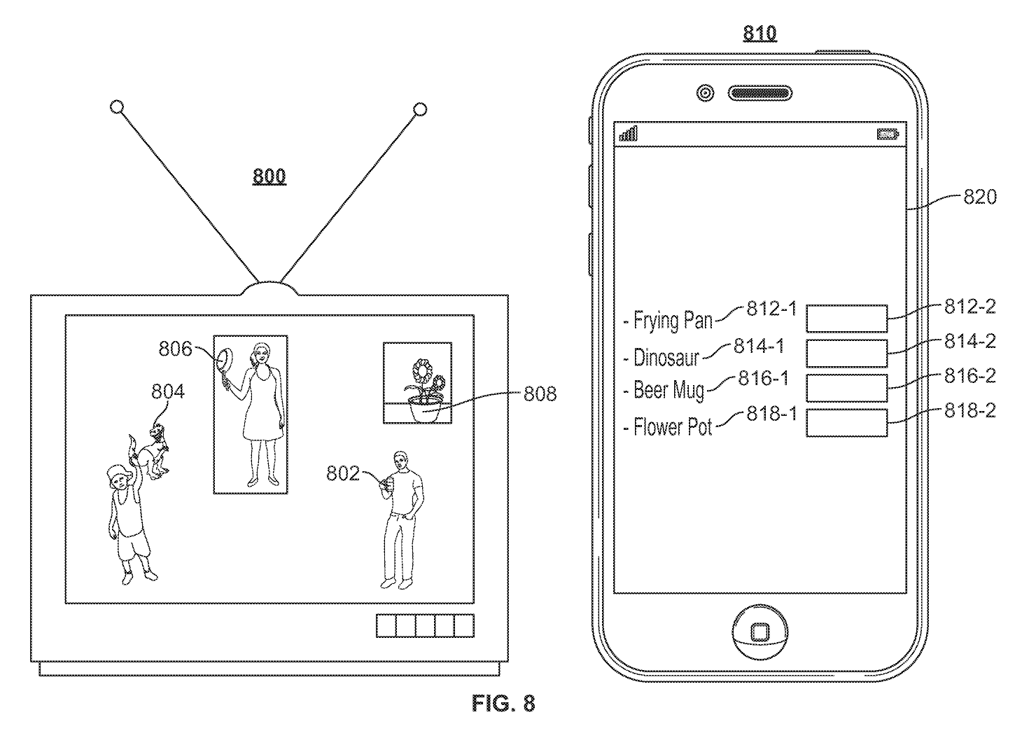

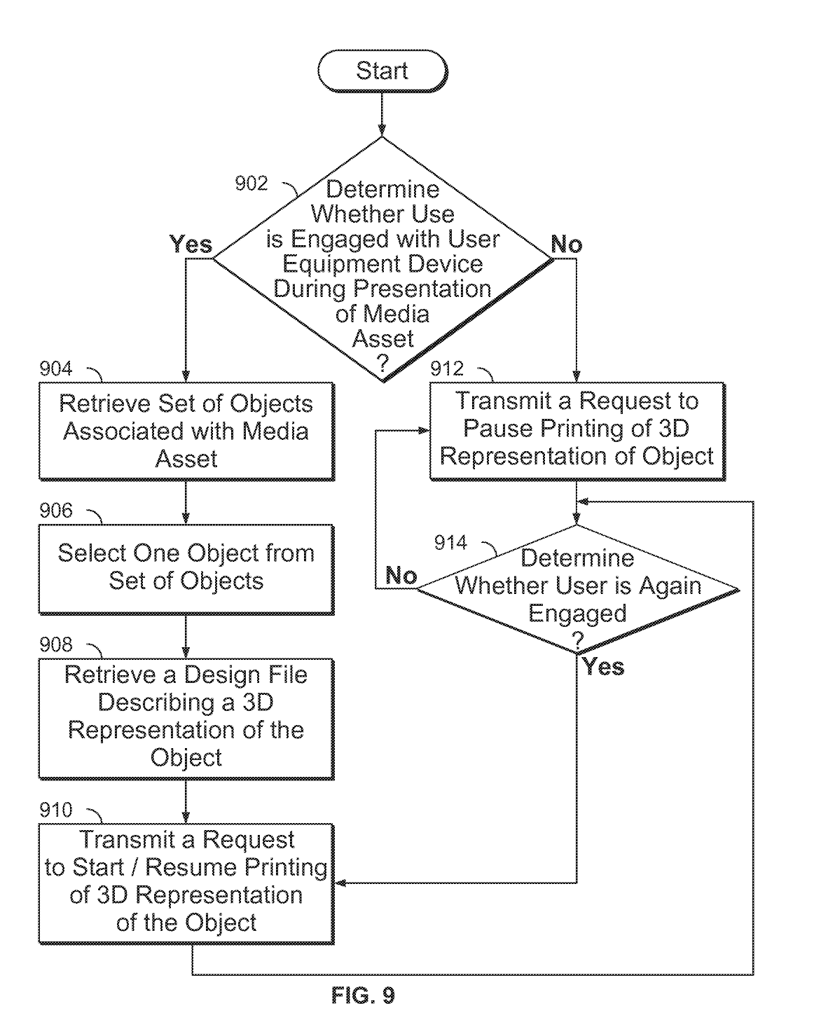

FIG. 8 shows an illustrative embodiment of a first user equipment device 800 and a second user equipment device 810, where the second user equipment device reflects selectable objects of a video frame presented at the first user equipment device, in accordance with some embodiments of the disclosure. User equipment device 810 may be a portable electronic device, such as a tablet computer (e.g., iPad). Control circuitry 304 may generate a display including selectable objects 802, 804, 806, and 808. Control circuitry 304 may cause user equipment device 810 to selectively display objects of a video from a particular frame, scene, or range of elapsed times, to the exclusion of other objects, based on a user profile in a manner described above with regard to FIG. 5A. Alternatively, control circuitry 304 may cause user equipment device 810 to display any or all objects of a video from a particular frame, scene, or range of elapsed times without regard to a user profile.

Display 820 is presented in list form for illustrative purposes only. Display 820 may be generated by control circuitry 304 to present an image that is identical or similar to that displayed in user equipment 800. Display 820 may include a list of object identifiers 812-1, 814-1, 816-1, and 818-1, each of which is adjacent to a selectable icon 812-2, 814-2, 816-2, and 818-2. Selectable icons 812-2, 814-2, 816-2, and 818-2 may be selectable images that depict a representation of the object described by respective object identifiers 812-1, 814-1, 816-1, and 818-1. In some embodiments, object identifiers 812-1, 814-1, 816-1, and 818-1 may themselves be interactive and selectable. In some embodiments, where display 820 depicts an image that is the same or identical to that displayed by user equipment 800, objects that have associated design files may themselves be selectable. For example, a user may be able to select by clicking on or touching frying pan 806 at user equipment 800 via user input interface 310 to instruct control circuitry 304 to retrieve a design file that specifies a 3D representation of frying pan 806. When an object is selected, control circuitry 304 may process the printing of a three-dimensional representation of the object in any manner described in the foregoing.

In some embodiments, control circuitry (e.g., control circuitry 304) may generate for display a selectable option that enables a user to contribute a design file for an object, or to select a user-contributed design file for an object. The display of the selectable options may be generated in response to receipt of a selection of an object by control circuitry 304. For example, if a toy dinosaur is selected in a video frame, an option to contribute a user's own design file that specifies a 3D representation of the toy dinosaur may be generated for display by control circuitry 304. Another option to select a design file that was contributed by a different user may also be generated for display by control circuitry 304.

FIG. 9 is a flowchart of illustrative steps taken to print a three-dimensional object as a reward for a user viewing a media asset on a user equipment device, in accordance with some embodiments of the disclosure. In step 902, control circuitry (e.g., control circuitry 304) may determine whether the user is engaged with user equipment device 300a during presentation of a portion of a media asset, e.g., a video. Though the entire media asset may be presented to the user, the user's engagement with user equipment device 300a may be determined during only the portion of the media asset. In some embodiments, the portion of the media asset may include a quarter, a half, or a three-quarter of the duration of the media asset. Alternatively, the user's engagement with the user equipment device may be determined during the entire media asset. If the user is determined to be engaged with user equipment device 300a, in step 904, control circuitry 304 may identify an object presented within the video (e.g., beer mug 502a, toy dinosaur 504a, frying pan 506a, and flower pot 508a) being viewed by a user. The object may be identified automatically or may be identified via user input (e.g., geometric shape 510b). In step 906, control circuitry 304 may select the object based on, e.g., a user profile or a viewing history. For example, if the user is Patsy, frying pan 506a may be selected by control circuitry 304 because of Patsy's profile indicating interest in cooking television shows. In another example, if the user is Patsy, frying pan 506a may be selected by control circuitry 304 because Patsy's viewing history includes cooking television shows.

In step 908, control circuitry 304 may retrieve a design file describing a three-dimensional representation of the object. For example, the design file may specify any object characteristic associated with a three-dimensional representation of the object for printing, such as (but not limited to) height, width, length, materials (e.g., plastic, metal, etc.), cost, color, and the like. In step 910, control circuitry 304 may transmit a request to a printer to print the three-dimensional representation of the object in accordance with the specifications of the design file. For example, if the design file specifies a 3D representation of frying pan 506a is to be cast iron, ten inches in diameter, and to have a steel handle that is five inches long that is to be printed as a separate component, control circuitry 304 may send consistent instructions to 3D printer 426 to print a 3D representation of frying pan 506a that satisfies those specifications.

If the user is determined to not be engaged with user equipment device 300a, in step 912, control circuitry 304 may transmit a request to pause printing of the three-dimensional representation of the object. At step 914, control circuitry 304 may check if the user is again engaged with user equipment device 300a. If so, at step 910, control circuitry 304 may transmit a request to resume printing of the three-dimensional representation of the object. If the user is not engaged, control circuitry 304 may continue to monitor the user to determine whether to pause or resume printing of the three-dimensional representation of the object.

In some embodiments, control circuitry (e.g., control circuitry 304) may make a determination of which object in a video being viewed by a user is most relevant to the user. Control circuitry 304 may identify user characteristics associated with a user profile or a viewing history (e.g., printer capabilities or previously viewed media asset), and determine which object has a greatest number of object characteristics that match the user characteristics associated with the user profile or viewing history. For example, control circuitry 304 may determine that beer mug 502a is associated with characteristics such as football, and may determine that a user has a viewing history of watching football, and may therefore determine beer mug 502a shares more characteristics with the viewing history than other objects in a video.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure.

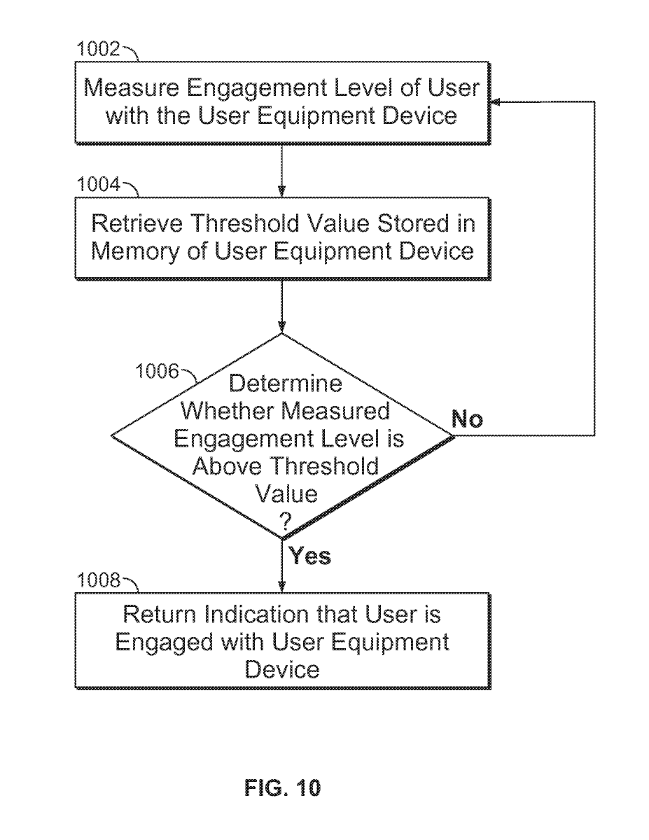

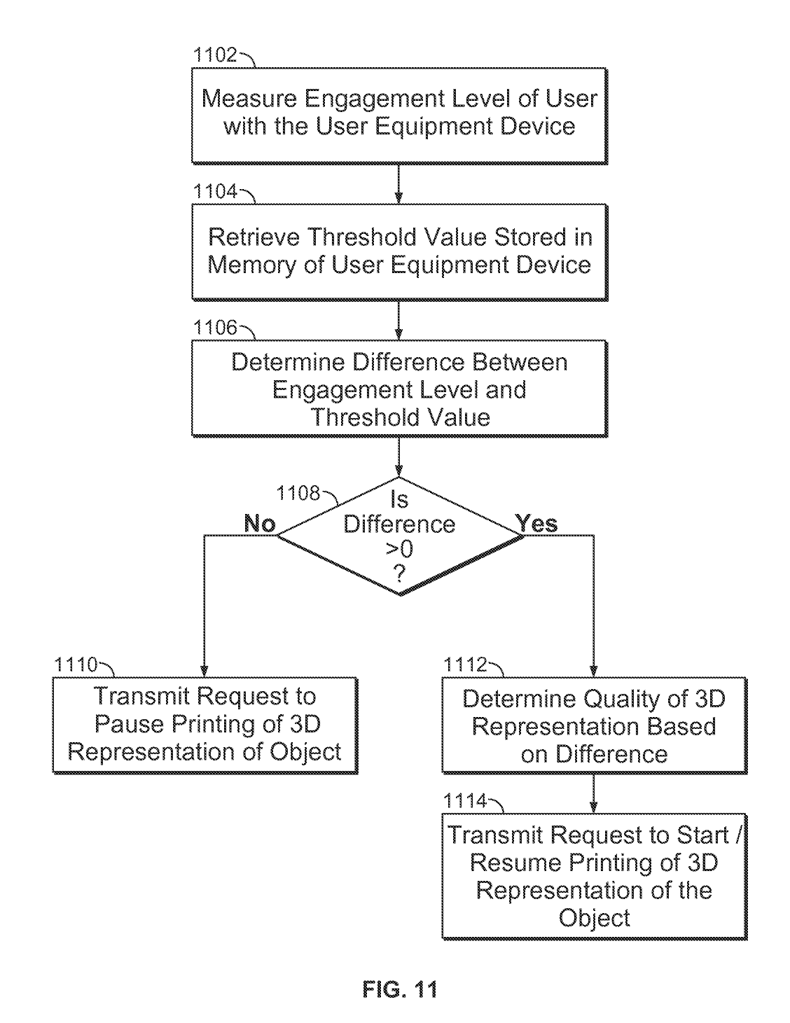

FIG. 10 illustrates a flow diagram containing processes in accordance with an embodiment that describes the process in which a user's engagement level with a user equipment during presentation of a media asset is determined in step 902 of FIG. 9.

At step 1002, control circuitry 304 measures an engagement level of the user with user equipment device 300a during a portion of a media asset presented to the user, e.g., a video. In some embodiments, the portion of the media asset presented to the user may include a quarter, a half, or a three-quarter of the duration of the media asset. Control circuitry 304 may calculate the user engagement level with user equipment device 300a using an eye contact score and a face tracking score. Control circuitry 304 may perform a weighted average of the face tracking score and eye tracking to calculate the user engagement level with user equipment device.

In some embodiments, control circuitry 304 receives eye tracking and face tracking data from engagement tracking circuitry 316, in particular from face tracker 318 and eye tracker 320. Control circuitry 304 may process the eye tracking data and face tracking data received from engagement tracking circuitry 316 and calculates an eye tracking score and a face tracking score. For example, processor 302b of eye tracker 300b may analyze eye tracking information received from optical sensor and calculates a numerical score based on the received eye tracking information. Similarly, processor 302c of face tracker 300c may analyze face tracking information received from image sensor 306c and infrared sensor 310c and calculates a face tracking score by processing the received face tracking using a face tracking algorithm. Processor 302c may calculate the face tracking score by analyzing a set of images or a video received from image sensor 306c and infrared sensor 306c to determine the level of engagement that the user has with respect to user equipment device 300a.

At step 1004, control circuitry 304 may retrieve a threshold value for the user engagement level from storage 308 of user equipment device 300a. At step 1006, control circuitry 304 may determine whether the user is engaged with user equipment device 300a. If the calculated user engagement value is above the retrieved threshold value, at step 1008, control circuitry 304 may return an indication that the user is engaged with user equipment device 300a. Such a determination may be made by processing data received from engagement tracking circuitry 316. If the calculated user engagement value is not above the retrieved threshold value, control circuitry 304 may return to step 1002 to measure the engagement level of the user. Optionally, control circuitry 304 may return an indication that the user is not engaged with user equipment device 300a.

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure.

FIG. 11 illustrates a flow diagram containing processes in accordance with an embodiment that describes the process in which a user's engagement level with a user equipment device during a portion of a media asset presented to the user is used to determine quality of a three-dimensional representation of an object.

At step 1102, control circuitry 304 measures an engagement level of the user with user equipment device 300a during a portion of a media asset presented to the user, e.g., a video. In some embodiments, the portion of the media asset presented to the user may include a quarter, a half, or a three-quarter of the duration of the media asset. Control circuitry 304 may calculate the user engagement level with user equipment device 300a using an eye contact score and a face tracking score. Control circuitry 304 may perform a weighted average of the face tracking score and eye tracking to calculate the user engagement level with user equipment device.

In some embodiments, control circuitry 304 receives eye tracking and face tracking data from engagement tracking circuitry 316, in particular from face tracker 318 and eye tracker 320. Control circuitry 304 may process the eye tracking data and face tracking data received from engagement tracking circuitry 316 and calculates an eye tracking score and a face tracking score. For example, processor 302b of eye tracker 300b may analyze eye tracking information received from optical sensor and calculates a numerical score based on the received eye tracking information. Similarly, processor 302c of face tracker 300c may analyze face tracking information received from image sensor 306c and infrared sensor 310c and calculates a face tracking score by processing the received face tracking using a face tracking algorithm. Processor 302c may calculate the face tracking score by analyzing a set of images or a video received from image sensor 306c and infrared sensor 306c to determine the level of engagement that the user has with respect to user equipment device 300a.

At step 1104, control circuitry 304 may retrieve a threshold value for the user engagement level from storage 308 of user equipment device 300a. At step 1106, control circuitry 304 may determine the difference between the calculated user engagement level and the retrieved threshold value. At step 1108, control circuitry 304 may analyze the determined difference. If the difference is below or equal to zero, at step 110, control circuitry 304 may return an indication that the user is not engaged with user equipment device 300a and transmit a request to pause printing of the three-dimensional representation of the object. If the determined difference is above zero, at step 1112, control circuitry 304 may determine the quality of the three-dimensional representation of the object to be printed based on the difference. For example, if the user is marginally engaged above the threshold value (e.g., the difference is less than 10% of the threshold value), the quality may be set to “low.” In another example, if the user is extensively engaged above the threshold value (e.g., the difference is more than 50% of the threshold value), the quality may be set to “high.” At step 1114, control circuitry 304 may return an indication that the user is engaged with user equipment device 300a and transmit a request to start or resume printing of the three-dimensional representation of the object according to the determined quality.

In some embodiments, the quality of the printed three-dimensional representation of the object may vary in quality as the measured engagement level of the user varies. In some embodiments, the quality may be locked in after a certain event, e.g., after the user has viewed more than half of the media asset, and subsequent user engagement level may not further affect the quality of the printed three-dimensional representation of the object.

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure.

It will be apparent to those of ordinary skill in the art that methods involved in the present disclosure may be embodied in a computer program product that includes a computer usable and/or readable medium. For example, such a computer usable medium may consist of a read-only memory device, such as a CD-ROM disk or conventional ROM devices, or a random access memory, such as a hard drive device or a computer diskette, having a computer readable program code stored thereon. A computer usable medium may be a transitory medium (e.g., a carrier wave or signal) or a non-transitory medium (e.g., a hard drive device). It should also be understood, that methods, techniques, and processes involved in the present disclosure may be executed using processing circuitry. For instance, identifying user characteristics associated with a user profile as described herein may be performed by processing circuitry, e.g., by processing circuitry 306 of FIG. 3A. The processing circuitry, for instance, may be a general purpose processor, a customized integrated circuit (e.g., an ASIC), or a field-programmable gate array (FPGA) within user equipment 108 or one of servers 122 of FIG. 1. For example, the user profile information as described herein may be stored in, and retrieved from, storage 308 of FIG. 3A, or media guidance data source 418 of FIG. 4. Furthermore, processing circuitry, or a computer program, may update settings associated with a user equipment, such as 3D printer capabilities, updating the information stored within storage 308 of FIG. 3A or media guidance data source 418 of FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for printing a three-dimensional object as a reward for a user viewing a media asset on a user equipment device, the method comprising:
determining whether the user is engaged with the user equipment device during presentation of a portion of the media asset;
in response to determining that the user is engaged during the portion of the media asset presented to the user:
determining an object associated with the media asset being viewed by the user;
retrieving a design file describing a three-dimensional representation of the object; and
transmitting a request to a printer to print the three-dimensional representation of the object.

2. The method of claim 1, further comprising:
in response to determining that the user is not engaged during the portion of the media asset presented to the user:
transmitting a request to the printer to pause printing of the three-dimensional representation of the object.

3. The method of claim 2, wherein the printing is resumed in response to determining that the user is again engaged during the portion of the media asset presented to the user.

4. The method of claim 1, wherein the portion of the media asset presented to the user comprises one of a quarter, a half, and a three-quarter of the media asset.

5. The method of claim 1, wherein determining whether the user is engaged with the user equipment device comprises:
measuring an engagement level of the user with the user equipment device;
retrieving a threshold value stored in a memory of the user equipment device; and
determining whether the measured engagement level of the user with the user equipment device is above the threshold value.

6. The method of claim 5, further comprising:
selecting a quality for the printing of the three-dimensional representation of the object based on the measured engagement level.

7. The method of claim 5, further comprising:
tracking the facial position of the user with respect to the user equipment device to measure the engagement level of the user with the user equipment device.

8. The method of claim 5, wherein measuring the engagement level of the user with the user equipment device further comprises:
tracking a gaze point of the user with respect to the user equipment device; and
setting a value to the engagement level of the user with the user equipment device based on the gaze-tracking.

9. The method of claim 1, wherein the object associated with the media asset is determined based on a user profile.

10. The method of claim 1, wherein the object associated with the media asset is determined based on a viewing history for the user.

11. A system for printing a three-dimensional object as a reward for a user viewing a media asset on a user equipment device, the system comprising:
control circuitry configured to:
determine whether the user is engaged with the user equipment device during presentation of a portion of the media asset;
in response to determining that the user is engaged during the portion of the media asset presented to the user:
determine an object associated with the media asset being viewed by the user;
retrieve a design file describing a three-dimensional representation of the object; and
transmit a request to a printer to print the three-dimensional representation of the object.

12. The system of claim 1, further comprising control circuitry configured to:
in response to determining that the user is not engaged during the portion of the media asset presented to the user:
transmit a request to the printer to pause printing of the three-dimensional representation of the object.

13. The system of claim 12, wherein the printing is resumed in response to determining that the user is again engaged during the portion of the media asset presented to the user.

14. The system of claim 11, wherein the portion of the media asset presented to the user comprises one of a quarter, a half, and a three-quarter of the media asset.

15. The system of claim 11, wherein the control configured to determine whether the user is engaged with the user equipment device comprises control circuitry configured to:
measure an engagement level of the user with the user equipment device;
retrieve a threshold value stored in a memory of the user equipment device; and
determine whether the measured engagement level of the user with the user equipment device is above the threshold value.

16. The system of claim 15, further comprising control circuitry configured to:
select a quality for the printing of the three-dimensional representation of the object based on the measured engagement level.

17. The system of claim 15, further comprising control circuitry configured to:
track the facial position of the user with respect to the user equipment device to measure the engagement level of the user with the user equipment device.

18. The system of claim 15, wherein control circuitry configured to measure the engagement level of the user with the user equipment device further comprises control circuitry configured to:
track a gaze point of the user with respect to the user equipment device; and
set a value to the engagement level of the user with the user equipment device based on the gaze-tracking.

19. The system of claim 11, wherein the control circuitry is configured to determine the object associated with the media asset based on a user profile.

20. The system of claim 11, wherein the control circuitry is configured to determine the object associated with the media asset based on a viewing history for the user.

21-30. (canceled)
